(19) United States
(12) Patent Application Publication
(10) Pub. No.: US 2003/0204275 A1
(43) Pub. Date: Oct. 30, 2003

(54) Sports charting system

(76) Inventor: Ronald Lee Krubeck, Boulder, CO (US)

Correspondence Address: PATTON BOGGS, PO BOX 270930, LOUISVILLE, CO, 80027, US

(21) Appl. No.: 10/133,868

(22) Filed: Apr. 26, 2002

(51) Int. Cl. G06F 155/00

(52) U.S. Cl. 700/91

(57) ABSTRACT

The sports charting system operates on standard portable and non-portable electronic processing devices. The sports charting system stores and displays a sport environment and stores and accepts user data input relating to statistics and player and sport apparatus positions relative to the sport environment. The sports charting system then generates real-time statistics from the user inputted player and sport apparatus positions. Tactical information and practice drills are derived from the stored real-time statistics and displayed to the user to communicate the tactical and mechanical strengths and weaknesses of a player.

### FIELD OF THE INVENTION

The field of invention involves a sports charting system that is operated on an electronic processing device.

### PROBLEM

Many athletes today are engaged in an ongoing process to keep their bodies fit and discover or chart flaws and weaknesses of their own individual performances. By charting and correcting these flaws and weaknesses, they can effectively improve their own skill level. In addition, many athletes are further engaged in identifying or charting their opponent's flaws and weaknesses. This charting process can be beneficial for the athlete who can exploit his opponent's flaws and weaknesses. One such way an athlete can determine the flaws and weaknesses of his opponent is to chart his opponent's performances. For over a hundred years, baseball managers have been matching particular pitchers with particular batters, and vice versa, in hopes of increasing the success of the team, by increasing the particular outcome of the batter/pitcher duel. Almost all athletes today are benefited by careful data collection and statistical analysis of either their own performances or the performances of their opponents.

One problem with the current data collection process of an athlete's performance is the lack of user-friendly sports information gathering apparatus. It is known in the art that personal computers and laptop computers have been used at sporting events to chart the performance of athletes and competitors. However, these computers fail to have the necessary combination of mobility, portability and power self-sufficiency to effectively be transported between sports events and to be used by a user in the stands or by a coach on the sidelines of the sporting event.

Another problem with current statistical analysis of an athlete's performance is the lack of meaningful data. Existing sports information-gathering apparatus are limited by the functions that they offer. Some sports information gathering apparatus offer scheduling and opponents' contact information. Some sports information gathering apparatus offer limited charting capabilities, like charting only the serve of a player. Other sports information gathering apparatus offer season and league ranking systems. None of these sports information gathering apparatus are focused on charting a sports performance for the purpose of improving a player's skills and/or uncovering flaws and weaknesses of an opponent.

Another problem with current technology regarding data collection and statistical analysis is the cost. Existing sports information gathering apparatus are very expensive and generally beyond the affordability range of most players and coaches.

Another problem with current technology regarding data collection and statistical analysis is that the data cannot be entered in real-time. It is known in the art that some existing procedures for charting a sports performance involve recording on paper a limited amount of statistics and then later transferring the recorded paper results to a personal computer. Another such procedure involves mailing the paper record to another party who enters the data into another system and then transfers the summarized data to the player. This creates redundant data entry and time delay in receiving the charting results.

Another problem with current technology regarding data collection and statistical analysis is that the score and data must be entered by hand. In the prior art, a player's score is entered by marking certain score boxes. In the prior art, users are required to enter each single data point by clicking or highlighting boxes regarding the locations of the players and a ball. This is time consuming, difficult, and error-prone during a fast paced match.

Another problem with current technology regarding data collection and statistical analysis is the inability to chart several matches that are concurrently in play. If a person is charting a first match and later starts charting a second match, while the first match is still in play, the existing sports information gathering apparatus doesn't allow the person to return to the first match and update and adjust the score and player positions of the first match.

Another problem with current technology regarding data collection and statistical analysis is the lack of artificial intelligence. A person charting a particular match must enter by hand all of the data and information regarding a match and its players. The current technology doesn't offer artificial intelligence capabilities to heuristically predict data and information needed for the statistical analysis of a match. Without artificial intelligence, the user must enter far more information and data which is both time consuming and prone to error.

Information relevant to attempts to address these problems can be found in U.S. Pat. Nos. 4,237,372 issued Dec. 2, 1980 to Zevgolis, et al.; 5,153,826 issued Oct. 6, 1992 to Johnson; 4,128,893 issued Dec. 5, 1978 to Johnson, et al.; 5,134,565 issued Jul. 28, 1992 to Herbertz; 4,097,855 issued Jun. 27, 1978 to Salvo and 5,898,751 issue Apr. 27, 1999 to Yakoby, et al.;. However, each one of these references suffers from one or more of the following disadvantages: redundant and time consuming data entry, limited statistics, limited portability, lack of artificial intelligence and expensive applications.

### SOLUTION

The above-described problems are solved and a technical advance achieved by the sports charting system that operates with existing electronic data processing devices to provide useful sports data and statistical analysis to athletes and coaches. The sports charting system operates on a computing system, such as the presently used standard personal computers, PDA's and PDA/cellular phones. The sports charting system can be easily transported to sporting events, and operated in the stands or on the sidelines of a sports event.

The sports charting system charts meaningful performance statistics of one or more players in a sports event or in a practice situation. The sports charting system records: players' position, sport apparatus position, real-time statistics and other meaningful data. The sports charting system also provides default values for a plethora of information derived from a player's properties profile to create a more efficient system for charting sports performances. The sports charting system generates trending information, tactical information and practice drills from the stored statistics to assist a player in improving their game tactically and mechanically.

As data is being input by the user, the sports charting system generates and displays statistics on-the-fly and in real-time. The scoring for a sport performance is kept and displayed instantly in response to the input of players' locations and ball location.

In the example of a tennis match, the sports charting system generates statistics and data from the player locations and the ball location. For example, the sports charting system, upon a first service location out and a second service location out data input from a user, automatically generates a double fault statistic for the server without the user checking or highlighting an extra data entry for this statistic. The sports charting system automatically generates point statistics, upon the input from a user of a winning player's position, winning player's ball location and the losing player's position, without any further input from the user. The sports charting system knows the rules of tennis and dynamically derives, in real time, the status and score of a serve, point, game, set and match from the location of the players and ball relative to the sport environment. The sports charting system advances the score and places the players in the correct location relative to each other and the sports environment prior to the beginning of each point.

The sports charting system is capable of charting several matches that are being simultaneously played. A user of the sports charting system can chart several matches at the same time. The user can chart a first match with the sports charting system and then chart a second, third, fourth, etc. match. The user can then go back and forth between matches and update and adjust the score and player positions of the ongoing matches.

The sports charting system uses artificial intelligence to assist a user charting a sports performance in determining data and information. The sports charting system heuristically predicts default values based on player profile information, sport performance rules, common practices and well-established facts of a particular sport. The data and information generated by the artificial intelligence reduces the amount of data and information that the user must enter and reduces the amount of errors due to human input.

While the present invention is contemplated primarily for utilization with tennis, it is noted that the sports charting system is likewise suitable for utilization with other diverse sports employing a field or court, including, for example: volleyball, horseshoes, football, baseball, hockey, soccer, rugby, cricket, foosball, basketball, and the like. The above and other problems are solved and an advance in the art is made by the sports charting system.

### DESCRIPTION OF THE DRAWINGS

The above and other features of present invention can be better understood from a reading of the detailed description and the following drawings:

FIGS. 1A, 1B and 1C illustrate electrical devices that operate the sports charting system;

FIG. 2 illustrates the home display for the sports charting system;

FIG. 3 illustrates a players display of the sports charting system;

FIGS. 4-6 illustrate a player properties display of the sports charting system;

FIG. 7 illustrates a matches display of the sports charting system;

FIGS. 8 and 9 illustrate a match properties display of the sports a charting system;

FIG. 10 illustrates the match notes display of the sports charting system;

FIG. 11 illustrates a first serve display of the sports charting system;

FIG. 12 illustrates a second serve display of the sports charting system;

FIG. 13 illustrates a playing display of the sports charting system;

FIG. 14 illustrates a playing display with a player and ball of the sports charting system;

FIG. 15 illustrates a win/loss—playing display of the sports charting system;

FIG. 16 illustrates a win/loss—return display of the sports charting system;

FIGS. 17-19 illustrate a statistics display of the sports charting system;

FIG. 20 illustrates a scoreboard screen display of the sports charting system;

FIGS. 21-22 illustrate an adjust score display of the sports charting system;

FIG. 23 illustrates a main screen menus display of the sports charting system;

FIG. 24 illustrates a serving and playing menus display of the sports charting system;

FIG. 25 illustrates a matches dialog menus display of the sports charting system;

FIG. 26 illustrates a players dialog menus display of the sports charting system;

FIG. 27 illustrates in flow diagram form the sports charting system processes for generating the required matches, sets, games, points and serves in a match;

FIG. 28 illustrates in flow diagram form the sports charting system match controller;

FIG. 29 illustrates in flow diagram form the sports charting system set controller;

FIG. 30 illustrates in flow diagram form the sports charting system game controller;

FIG. 31 illustrates in flow diagram form the sports charting system point controller;

FIG. 32 illustrates in flow diagram form the sports charting system serve and return flow; and

FIG. 33 illustrates in flow diagram form the sports charting system play and point flow.

### DETAILED DESCRIPTION

The sports charting system is capable of charting several concurrently active sporting performances of at least one player. To illustrate one embodiment of the present invention, the sport of tennis is described in detail below. Though tennis is one sport, the sports charting system is capable of charting many other sports. The sports charting system is operated on electronic processing devices and the data collected on one device is easily stored, displayed and transferred or downloaded to another electronic processing device.

A sporting performance is any activity involving physical exertion and having a set form and body of rules, which are stored in the sports charting system. The sports charting system utilizes the stored set of sport performance rules to make determinations regarding the score, player location, statistics and status of a point in a sporting performance. For example, in tennis when a player hits a ball out of bounds the sport performance rule is that the ball is out of play and that a certain player's score is advanced in a well-defined way because of the errant shot. The sport performance rules also describe the actions regarding scoring and statistics with respect to the specific events during a sport performance. The sports charting system, upon the input of data by a user that is indicative of an errant shot from a player, automatically makes the determination that the ball is out of play and advances the score and player location of the opposing player according to the rules of tennis and keeps statistics regarding the point, all based on the user input of a ball location. In another example, when the user inputs two consecutive serve locations as faults, then the sports charting system makes the determination that the ball was not served within the service court for two consecutive serves by the server and automatically advances the score of the non-serving player according to the rules of tennis and keeps statistics regarding the serve, all based on the user input of a ball location. In another example, the sports charting system, determines the score, player location, statistics and status of a point based on the user input of a winning point player's location, the ball location and the losing point player's location.

The sport performance rules include rules that pertain to score and statistics with regard to a particular sport performance. For example, in a basketball game, if a player dribbles the ball out of bounds the sport performance rules for basketball state that when a player dribbling a ball steps out of bounds or dribbles the ball out of bounds, then the ball is turned over to the other team for a throw in at the location that the player went out of bounds. For another example, in tennis, if a player hits the ball into the net and not over the net, then the score advances in a well-defined way for the opposing player. These rules are the cornerstone of all sporting performances. They define the sport performance and give the participants clear expectations regarding playing the sporting performance. Sport performance rules include the playing boundaries of the sport environment, size of the sport apparatus, number or participants, number of referees, etc. Sport performance rules also include what constitutes scoring and penalties of a sport performance.

The sporting charting system stores and displays the sport performance rules of a particular sport. The sport performance rules are stored to enable the sports charting system to make determinations regarding the score and statistics based solely upon player and sport apparatus locations as inputted by the user. The sports charting system displays the rules to a user or player in order to assist the players in solving rule-based disputes. In the example of charting a tennis match, the sports charting system rules include USTA tennis rules, NCAA tennis rules and USTA code of conduct.

The sporting performance can be played by one or more persons. In addition, the sporting performance can be played by one or more teams. A partial and non-inclusive list of sporting events includes: volleyball, horseshoes, football, baseball, hockey, soccer, rugby, cricket, foosball, basketball, and the like.

A sport environment is an area in which a sporting performance takes place. The sport environment usually has physical boundaries that define the sport environment. In the present invention, the sport environment is a tennis court. A sport apparatus is an object that is hit, chased, thrown, tossed, kicked, carried and struck pursuant to being used in a sporting performance. For instance, in a tennis match the sport apparatus is the tennis ball. In a hockey game the sport apparatus is the puck. In football, the sport apparatus is the football and in soccer, it's the soccer ball. The sport apparatus positional data is the position of the sport apparatus relative to the sport environment and players. The player positional data is the position of a player relative to the sport environment. Player positional data is also the position of a player relative to another player or to the sports apparatus.

A sport match definition is the general structure of the sporting performance. For example, sport match definition for a tennis match are 3-set matches, 5-set matches, Pro-Set matches, or other match subdivision definitions. Another example would be whether a baseball game is a 9-inning game or a 7-inning game. A sport match definition subdivision is the subdivision of the sport match definitions. For example, a standard 3-set has subdivisions such as games, points, tiebreak points and serves, all which the sports charting system generates. The user enters the sport match definition and the sports charting system generates the required number of sport match definition subdivision.

The sport game orientation means the orientation of the sport environment relative to the system. For example, a side view of a tennis court means that the sidelines of the tennis court are horizontal as viewed by the user. An end view of a tennis court means that the baseline of the tennis court is horizontal as viewed by the user. This enables the user to view the tennis court on the sports charting system as the user views the tennis court of the match the user is charting. The user can input environmental data and relevant variables that may impact a player's performance that is related to the sporting performance. For example, in a tennis match the user inputs environmental data like the type of court surface, temperature, wind speed, etc. Relevant variables that may impact a player's performance include number of days between sporting events, official nature of sporting event (practice versus professional competition), diet, and the like.

Layout of the Sports Charting System

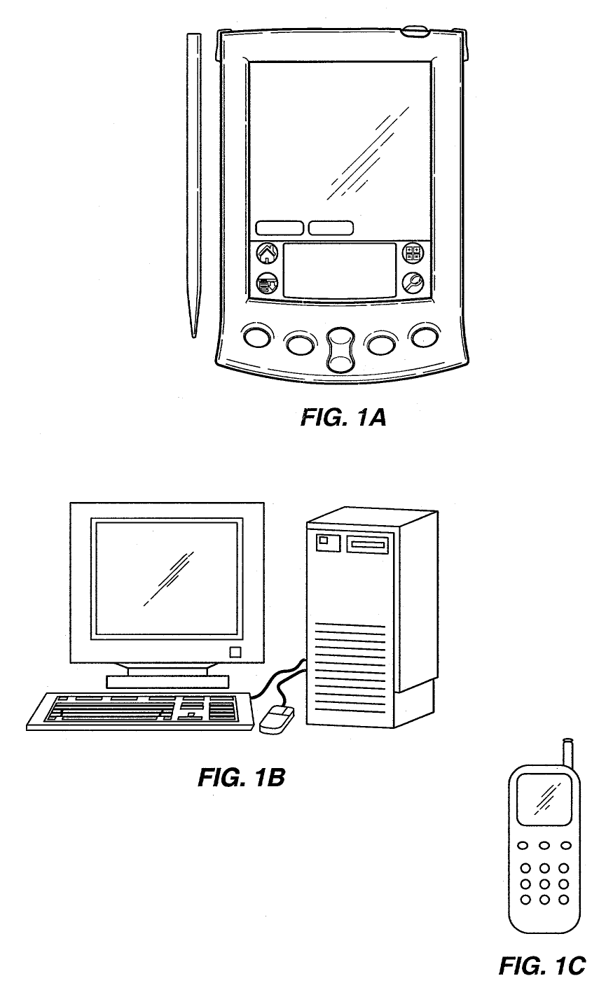

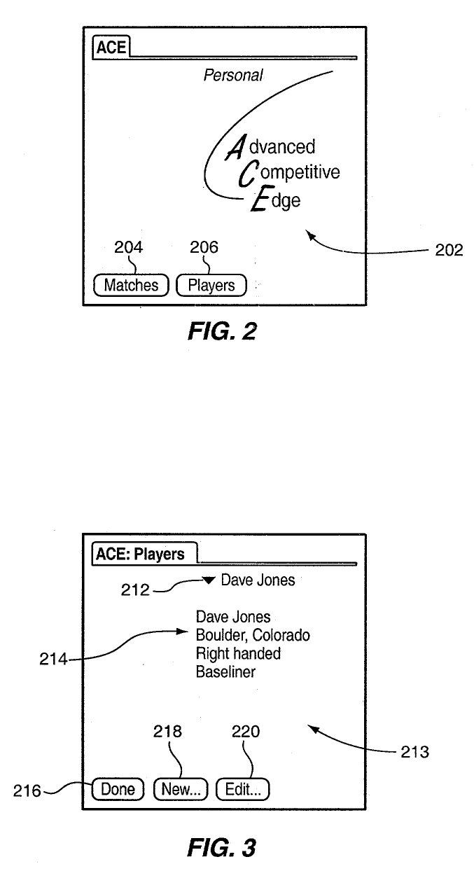

FIG. 1A is an illustration of a typical computing device, such as a personal digital assistant (PDA), FIG. 1B is an illustration of a personal computer and FIG. 1C is an illustration of a cellular phone/PDA combination. The sports charting system is capable of operating on these and other electronic processing devices. FIG. 2 is an illustration of the home display 202 of the sports charting system. The home display 202 is the display of a PDA, personal computer, cellular phone/PDA combination or other electronic processing device. The display 202 is capable of accepting input from the user. The sports charting system typically comprises software (or a combination of software and hardware) that is operable in the computing device to perform the functions as described herein. Since the sports charting system typically comprises program instructions, it is disclosed in the Figures herein as a series of flow diagrams that illustrate the operation of these program instructions. The sports charting system is an interactive system that requires user input to direct it's processing and displaying functions. The user input can be the point and click of a mouse on a personal computer, a pressure sensitive touch on a PDA screen, or other electronic apparatus inputting actions and devices such as: a keyboard, knobs, spin controls, joy sticks, touch pads and roller balls among other conventional inputting apparatuses. On the home display 202 are a players selection 206 and a matches selection 204.

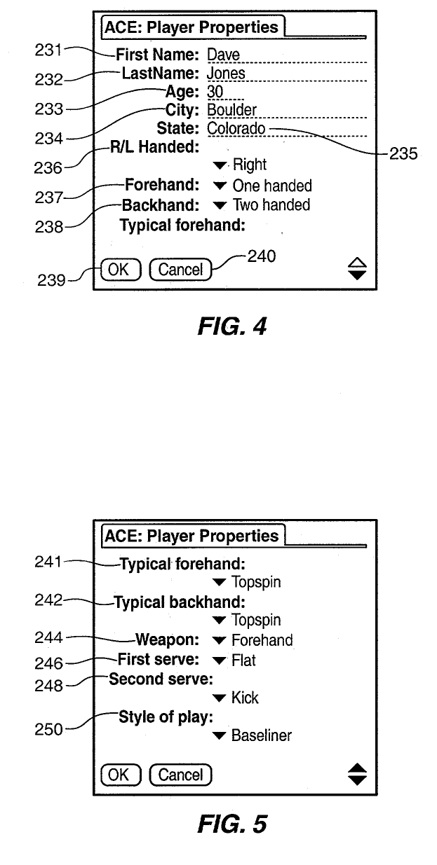

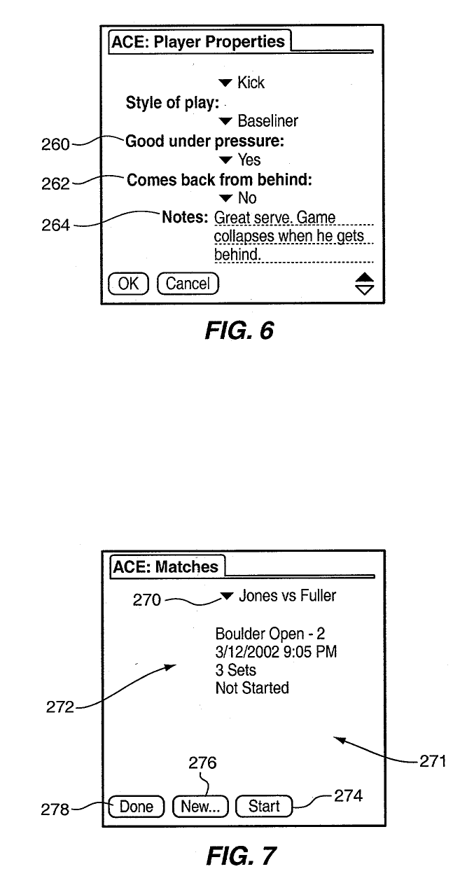

FIG. 3 is an illustration of a players display 213 when the players selection 206 is selected. The players display 213 comprises a players menu 212 which is a pull-down menu that lists the players and teams currently stored in the sports charting system. The players display 213 also displays general profile data 214 for a player or a team. The “done” selection 216 stores the players display 213 into the sports charting system and returns to the home display 202. FIGS. 4, 5 and 6 are an illustration of a player properties display 230. In FIG. 3, the new selection 218 allows a user to input a new player or team profile data into the player properties display 230. The edit selection 220 allows a user to edit a stored player or team profile data stored in the sports charting system. The sports charting system charts one or more players and teams simultaneously. The sports charting system captures information about every point played in a match. The sports charting system charts one or more players in practice to generate appropriate drills for each player to practice. Using match data, the sports charting system also generates suggested practice drills techniques and strategies based on players' performance.

The player properties display 230 displays and accepts user input for player or team profile data such as first name data field 231, last name data field 232, age data field 233, city data field 234 and state data field 235. The player properties display 230 also displays and accepts user input for sport specific player or team profile data in pull-down menus such as left/right handedness menu 236, forehand menu 237, backhand menu 238, typical forehand menu 241, typical backhand menu 242 and weapon menu 244. These pull-down menus contain lists of typical selections for each menu display. For instance, the left/right handedness menu 236 lists left or right as selections the user may select. Also the forehand menu 237 and backhand menu 238 each list selections one handed or two handed. The typical forehand menu 242 and typical backhand menu 242 list selections such as topspin, flat or slice. Player properties OK selection 239 stores the inputted data to persistent storage. Player properties cancel selection 240 returns to the player display 213.

The player properties display 230 also displays and accepts user input for player and team profile data such as a first serve menu 246 and second serve menu 248, both of which are pull-down menus that list flat, kick or slice as selections the user can select. The player properties display 230 also displays and accepts user input for player and team profile data such as style of play 250 which is a pull-down menu that lists all-court, baseliner, counter-puncher and serve and volley as selections the user can select. The player properties display 230 also displays and accepts user input for player and team profile data such as a good under pressure menu 260 and a comes from behind menu 262 both of which are pull-down menus that list yes or no as selections the user can select. The player properties display 230 also displays and accepts user input for player and team profile data in a notes section 264 that allows the user to type text freeform comments or notes related to a particular player. The player properties display stores other player profile data such as conditioning information, fitness schedules and player nutritional information.

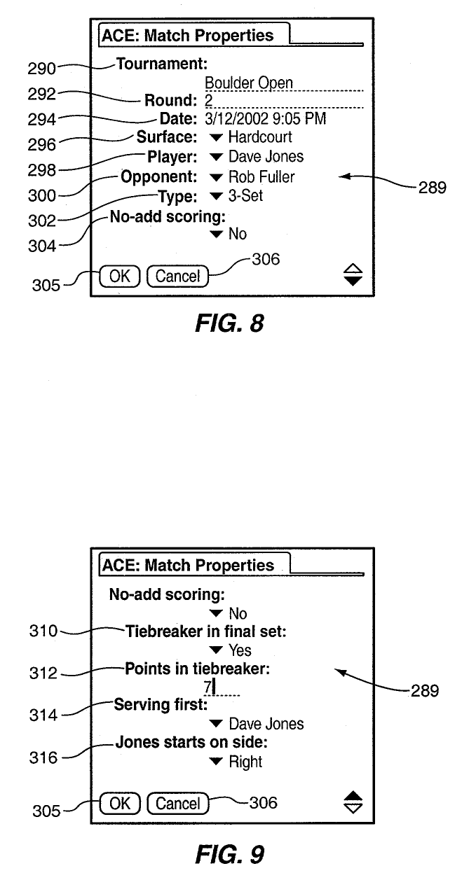

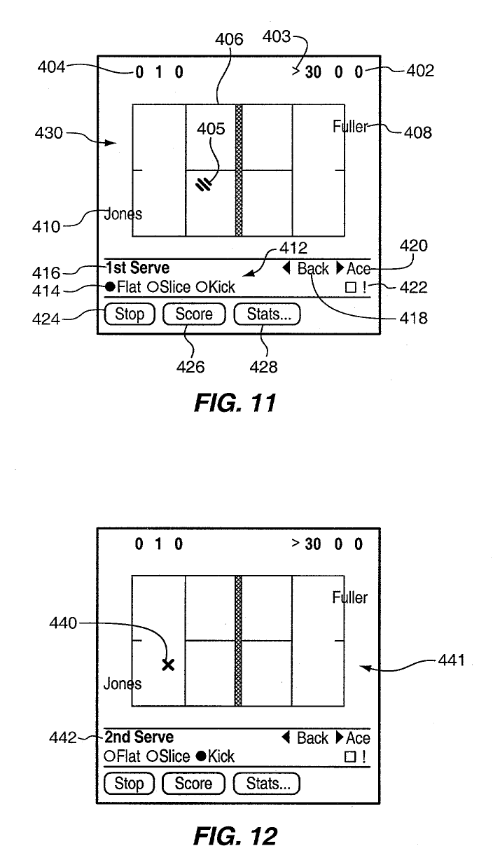

FIG. 7 is an illustration of the matches display 271 when the matches selection 204 is selected. Matches display 271 displays and accepts user input for match data. The matches display 271 displays and accepts user input for matches data in a competitors menu 270 which is a pull-down menu that lists stored competitors match ups. Match general information display 272 displays the summary of the match data stored for a particular selected match. When the done selection 278 is selected the home display 202 is displayed. When the new selection 276 is selected a match properties display 289 is displayed, as shown in FIG. 8. When the start selection 274 is selected the first serve display 430 is displayed as shown in FIG. 11.

FIGS. 8 and 9 are an illustration of the match properties display 289. The match properties display 289 displays and accepts user input for match data. Match properties display 289 comprises a tournament field 290 for entering the title of a match. Match properties display 289 also displays and accepts user input for matches data in a round field 292. The date field 294 is automatically generated by the sports charting system. Match properties display 289 also displays and accepts user input for matches data in a surface menu 296 which is a pull-down menu that lists grass, hardcourt and clay as selections the user can select. Match properties display 289 also displays and accepts user input for matches data in a player menu 298 and an opponent menu 300 which are pull-down menus that lists stored players and teams in the sports charting system that the user can select. Match properties display 289 also displays and accepts user input for matches data in a type menu 302 which is a pull-down menu that lists 3-Set, 5-Set and Pro-Set as selections the user can select. The sports charting system also creates custom scoring formats such as 8 game pro-set, no-add scoring, 7-point tiebreaker at 8 all, etc. The sports charting system stores multiple matches. Further, the sports charting system plays several matches simultaneously, enabling the user to chart several matches at the same time.

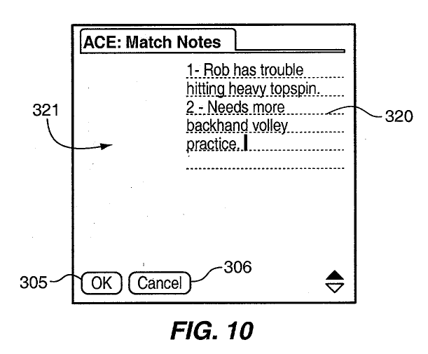

Match properties display 289 also displays and accepts user input for matches data in a no-add scoring menu 304 and a tiebreaker menu 310 which are a pull-down menus that lists “yes” or “no” as selections that the user can select. When the match properties OK selection 305 is selected the user input regarding the match properties is stored to the sports charting system and the matches display 271 is displayed. When the cancel selection 306 the user input regarding the match properties is not stored to the sports charting system and the matches display 271 is displayed. The match properties display 289 also displays and accepts user input for matches data in a points in tiebreaker data entry field 312 where the user inputs the number of points of the tiebreaker. The match properties display 289 also displays and accepts user input for matches data in a serving first menu 314 the stored players or teams entered in the player menu 298 and opponent menu 300 as entered prior by the user. The match properties display 289 also displays and accepts user input for matches data in a starts on side menu 316 which allows the user to input the orientation of the players prior to the start of a match. FIG. 10 is an illustration of the match notes display 321 that allows the user to type text freeform notes 320 related to a particular match. The sports charting system is capable of switching court perspective as viewed by the user. If the user is viewing the match from the end of the court then the tennis court display 406 can be displayed relative to the sports charting system 90 degrees to reflect the end view of the user. The sports charting system can display can be switched from side to side or end to end to reflect the view of the match of the user.

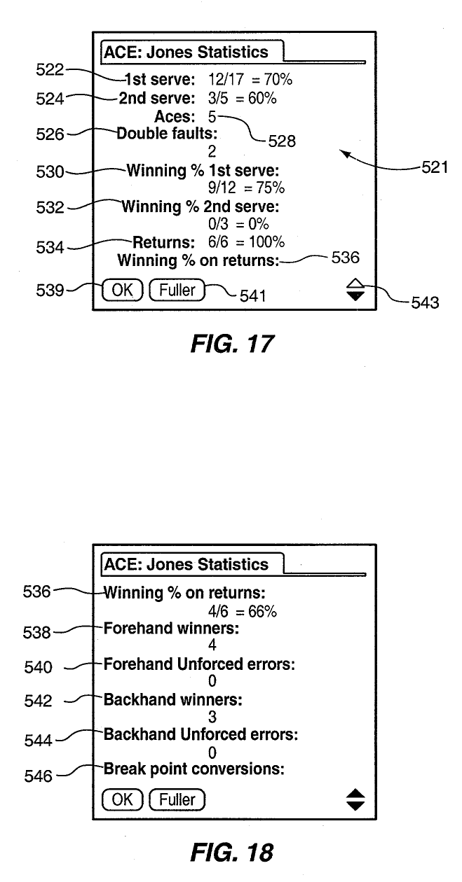

FIG. 11 is an illustration of the first serve display 430 of the sports charting system. A first player score 404 is displayed at the top left of the first serve display 430 and notes the sets, games and points from left to right for a first player. A second player score 402 is displayed at the top right of the serve display 430 and notes the points, games and sets from left to right for a second player. The first serve display 430 also includes a tennis court display 406. From the user inputted information the sports charting system places a first player 410 and a second player 408 in the required orientation with respect to the tennis court. This means that before the first serve of the match the players are located on in the deuce court and on the side according to the information provided by the user in the starts on side menu 316. Service display 416 shows that this is a first serve. The service type selection box 412 displays the choices of serve for the first serve. The user enters the type of first service in the service selection box 412. A service default value 414 is highlighted and corresponds to the player profile data for that particular player's first service as entered by the user during the player properties data entry. If the first serve is an ace, the user inputs the ace selection 420 and the sports charting system will automatically adjust the score of the match. If the point is a “pressure point” or one which is tension filled, such as a set point, break point, etc., then the user selects the pressure point selection 422. The pressure point selection 422 assists the user in charting the pressure points won by a player or an opponent. Selecting the stop selection 424 pauses the match and returns the sports charting system to the matches display 271. Selecting the score selection 426 will display the scoreboard display 570 as in FIG. 20. Selecting the stats selection 428 will display the player statistics display 521 as in FIG. 17. Serving player marker 403 displays which player is currently serving.

Default values are used by the sports charting system to anticipate real play, to expedite the data inputting process of the user and to reduce the number of erroneous inputs by the user. By storing player profile data entered by a user before a match begins, the sports charting system is able to enter specific player profile data into the corresponding data entry point alleviating the need by the user to do so. If a particular player has a strong forehand or backhand weapon, then the user notes it in the player profile section and the sports charting system will use this forehand or backhand value for the side shot hit on when the particular player hits a shot. The default values are also used in conjunction with player positional information to heuristically guess at forehand and backhand defaults. For example, if a player who is right-handed and is hitting cross-court shots in the deuce court, the sports charting system will heuristically predict that the player is hitting forehand shots. If in this example the player is the point winning player, then the default value for the winning point player shot side hit on selection 486 will be forehand. In another example, if the player is left-handed and is hitting cross-court shots in the add court, the sports charting system will heuristically predict that the player is hitting forehand shots. If in this example the player is the point winning player, then the default value for the winning point player shot side hit on selection 486 will be forehand. These default values can be changed by the user.

The sports charting system generates real-time statistics from the user input of the player position and the ball location during a match. The statistics can be viewed as entire match or displayed by set. The statistics can be viewed selectably such as by first set only, second set only, third set only, fourth set only or fifth set only. Allowing the user to view the statistics in any custom manner the user chooses, assists the user in determining whether a particular player is slow to warm up or quick to expire and other time-oriented trend analysis. The sports charting system is further capable of custom querying stored real-time statistics to answer virtually any kind of query regarding a particular player in a match or practice setting. For instance, the user may query if a particular player is at the net what happens, is that player generally successful or generally not successful when the player is located at the net. The sports charting system could further provide an answer to a custom query from the user regarding a particular player's backhand errors or where the opponent is most successful hitting winning shots.

The sports charting system also displays and determines tactical mistakes in structured format by either player. The sports charting system also charts the player stroke mechanics (e.g., weak wrist, etc.) in structured format by entering this data into the player profile (not shown). The sports charting system also recommends useful training techniques (i.e. practice drills) based upon statistics gathered. A user can input the results of the practice drills into the sports charting system and the sports charting system charts the practice drills to determine progress made.

The tactical information stored in the sports charting system includes information regarding a player's position relative to a losing shot, a player's position relative to a winning shot, a player's positional relationship to an opponent during a winning shot and a player's positional relationship to an opponent during a losing shot. Tactical information also includes a player's positional relationship relative to the sport environment and opponent's positional relationship relative to the sport environment. Tactical information also includes team member's positions to each other relative to a winning shot and team member's positions to each other relative to losing shot.

The first serve display 430 is an active screen and accepts input as to the ball location of the first serve. The sports charting system displays the location on the first serve display 430 of the ball location of the first serve as entered by the user. FIG. 11 displays an in serve marking 405 that is in the delimiters of the field of play. FIG. 12 is an illustration of the second serve display 441. The second serve display 441 is displayed when the first serve is out. Second serve display 441 displays where the first serve is located by an out serve marking 440. In serve marking 405 and out serve marking 440 have different designs to assure the user that the sports charting system correctly noted the user input regarding the ball location. The out serve marking 440 is an “X” and the in serve marking 405 is in the shape of a tennis ball. These are not limiting markings as the out serve marking 440 and the in serve marking 405 can be any design that differentiates an in serve from an out serve. FIG. 12 has many of the same features or displays as FIG. 11 and their description will not be repeated.

The second serve display 441 displays the same service type selection box 412 as in the first serve display 430. The inputted service default value 414 for the second serve is a kick serve in FIG. 12. The kick serve value was entered in the player properties by the user and is used as a default value in FIG. 12. This value can be changed to accommodate a change in type of service. If the second serve is marked out (not shown) then the sports charting system determines that a double fault has occurred and the score is automatically adjusted according to the rules of tennis. If either the first or second serve is in, then the sports charting system waits for the user to enter a service return ball location (not shown).

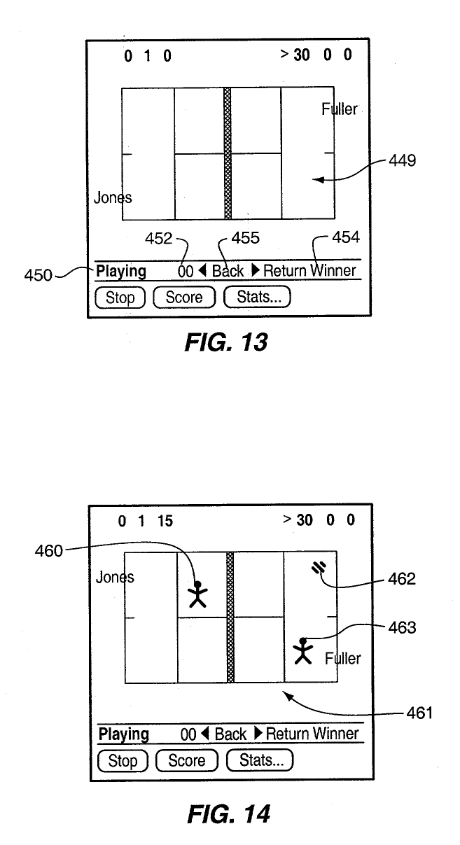

Once the service return ball location is highlighted or selected on the tennis court display 406 as being within the boundaries of the tennis court display 406, the sports charting system then displays the playing screen display 449 as in FIG. 13. If the user inputs the ball location of the service return to be out of the court, then the sports charting system places an “X” on the out of bounds service return and automatically adjusts the score of the match once it receives stroke data regarding the errant shot. The playing screen display 449 has a playing display 450 to inform the user that a point is being played. The actual strokes can be counted by entering each stroke into the stroke counter 452. The return winner selection 454 informs the sports charting system that the service return was a winning point and automatically adjusts the score of the match once it receives information regarding the winning shot. The back selection 455 returns in successive steps to the beginning of the current point of the match. Each click of the back selection 455 goes backward one logical step. For example, if the first serve is out, the second serve is in and the service return is in, then the sports charting system displays the playing screen display 461 (as shown in FIG. 14). When the back selection 455 is input the sports charting system returns to the second serve. Upon a further input of the back selection 455, the sports charting system returns to the first serve.

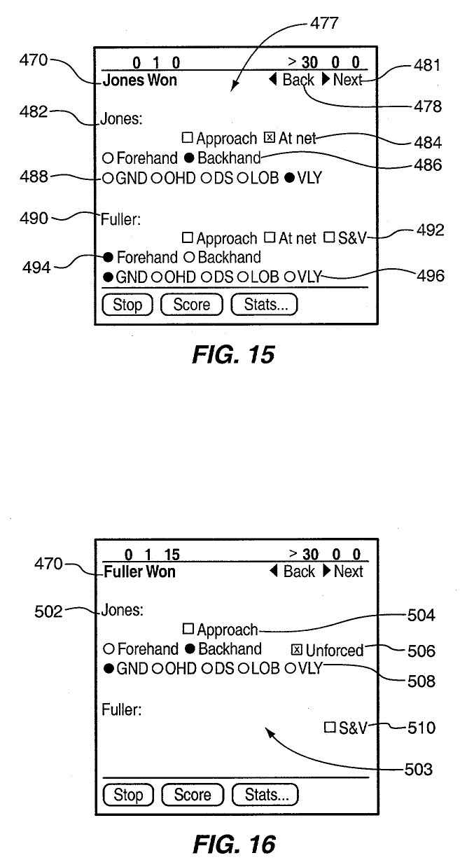

FIG. 14 is an illustration of the playing screen display 461 with a point winning player location 460. The sports charting system displays the position on the tennis court display 406 of the point winning player location 460 corresponding to the user input of the point winning player location 460. The user then inputs the point winning player's ball location 462 on the tennis court display 406. The user then inputs the point losing player's location 463. The sports charting system determines that the point is over and displays the win/loss-playing display 477 as in FIG. 15. The sports charting system determines the winning player and losing player of the previous point by the location of the point losing player location 463, the point winning player's ball location 462 and the point losing player location 463. The sports charting system also sets the ball location of the point losing player equal to the position of the point winning player location 460 when the point winning player location 460 is located within the boundaries of the point winning player's side of the tennis court. Where the point winning player location 460 is located outside the boundaries of the point winning player's side of the tennis court, then the sports charting system places the ball location of the point losing player inside the boundaries of the point winning player nearest the point winning player location 460. The sports charting system captures point winning player location 460, the point losing player location 463, the point winning player's ball location 462 and the losing player's ball location 461. The sports charting system determines, for charting purposes, the successes and failures of the players and teams involved in the sport.

The sports charting system scores matches automatically. The sports charting system requires no score input from the user. In one aspect, the sports charting system automatically determines the score in a match, set, game, point and serve and the locations of the players by the user inputs of the winning point player, the winning player ball location and the losing player location. In another aspect, the sports charting system automatically determines the score of a point by the losing point player location, the losing point player ball location and the winning point player location. In another aspect, the sports charting system automatically determines the score by the user inputs of a double fault. In another aspect, the sports charting system automatically determines the score by the user inputs of an ace serve. In another aspect, the sports charting system automatically determines the score by the user inputs of a losing player location and the location of an out ball. These inputting sequences and data inputs are not limitations to the system which is described herein, since a novel system concept is disclosed, not a specific inputting or data sequence limited implementation of an existing system concept.

FIG. 15 is an illustration of the win/loss-playing display 477 which is displayed once a point has finished. The back selection 478 returns the playing screen display 461. The back selection 478 can return to as many previous strokes, serves, games, sets and matches as the user desires. The next selection 480 displays the first serve display 430 for the next point to be played. The win/loss-playing display 477 displays the point winning player 470, point winning player information 482 and the point winning player location 460 from the user input from the previous point. The sports charting system determines the point winning player charting location 484 by placing an “x” mark in either the approach or at net checkboxes in the point winning player charting location 484. This value can be changed by the user by inputting the appropriate value. The sports charting system captures net approaches, by determining the location of the players relative to the tennis court display 406. The sports charting system will determine that a player was at the net, if a user inputs a player's location as being between the net and the service line.

Other information that is displayed by the win/loss-playing display 477 is the winning point player shot side hit on selection 486. A default value is displayed, which is derived from the player's positions as inputted by the user and the weapon menu 244 information as inputted by the user. The win/loss-playing display 477 also displays the type of point winning shot 488. The sports charting system determines the type of point winning shot 488, whether it is a groundstroke, overhead, dropshot, lob or volley, by the location of the point winning player location 460 relative to the tennis court display 406 and the point losing player's location 463 and the point winning player's ball location 462. The point losing player information 490 are also charted and displayed by the sports charting system. The point losing player charting location 492 is displayed and contains the checkboxes regarding the location of this player. The sport charting system determines the point losing player charting location 492 from the input of the point losing player location 463 from the user. Other information that is displayed by the win/loss-playing display 477 is the losing point player shot side hit on selection 486. A default value is displayed, which is derived from the player's positions as inputted by the user and the weapon menu 244 information as inputted by the user. The sports charting system uses the weapon menu 244 information inputted by the user as the default value. The win/loss-playing display 477 also displays the type of point losing shot 496. The sports charting system determines the type of point losing shot 496, whether it is a groundstroke, overhead, dropshot, lob or volley, by the location of the point losing player's location 463 relative to the tennis court display 406 and the point winning player's location 460 and the point winning player's ball location 462.

FIG. 16 is an illustration of the win/loss-return display 503 which is displayed when the winning point is won on a service return. The win/loss-return display 503 displays the point winning player 470. The winning point can be marked as a serve and volley point by marking the serve and volley checkbox 510. If the user entered serve and volley in the style of play 250 in the player properties display 230, then the sports charting system will use this value as a default value for the serve and volley checkbox 510 and the serve and volley checkbox 510 will have be selected. The win/loss-return display 503 also displays the point losing player information-return 502. Included in these point losing player information-return 502 are a checkbox that the user can check to indicate whether the point losing player was approaching the net 504 or an unforced error 506. The win/loss-return display 503 also displays the type of point losing shot 508. The sports charting system determines the type of point losing shot 508, whether it is a groundstroke, overhead, dropshot, lob or volley, by the location of the point losing player location 463 relative to the tennis court display 406 and the point winning player's location 460 and the point winning player's ball location 462.

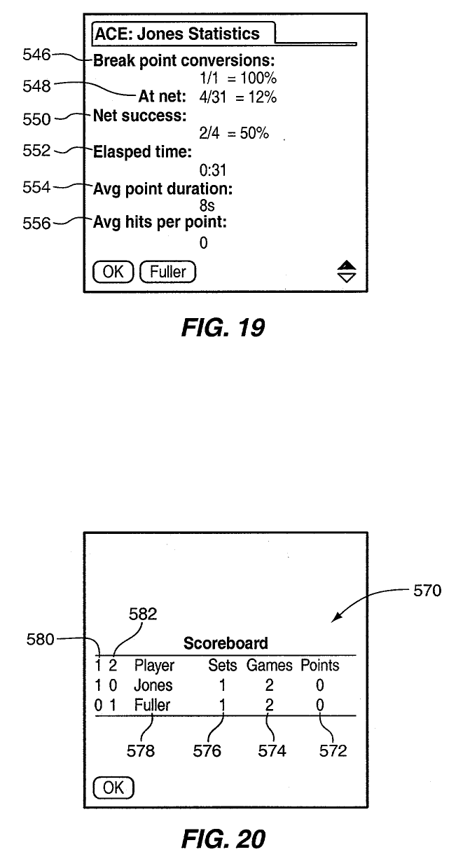

FIGS. 17, 18 and 19 are illustrations of a player's statistics display 521. These statistics are kept for all players and teams being charted by the sports charting system. These real-time statistics are generated by the user input of ball locations and the player locations of each point. From this data the sports charting system determines the statistics. Some of the statistics generated and displayed by the sports charting system relate to the serving efficiency of a player. Some of these statistics are first serve percentage 522, second serve percentage 524, aces 526 and double faults 526. The sports charting system captures double faults by determining the ball location inputted by the user. If the user inputs a first serve outside the service square in the tennis court display 406, the sports charting system will display an “X” for that first fault serve. If the server then serves a second serve the user will input the location of the second fault serve and the sports charting system will display an “X” for that second fault serve and will automatically score the second fault serve as a double fault and automatically adjust the score of the match according to the rules of tennis.

Serve related statistics for a player are generated and displayed by the sports charting system. Among these statistics are point winning percentage on first serves 530 and point winning percentage on second serves 532. Return related statistics for a player are generated and displayed by the sports charting system. Among these statistics are returns 534 and winning percentage on returns 536. Side shot hit on statistics for a player are generated and displayed by the sports charting system. Among these statistics are forehand winners 538, forehand unforced errors 540, backhand winners 542 and backhand unforced errors 544. Statistics OK selection 539 returns to the first serve display 430. The sports charting system displays another player's statistics when the user inputs player statistics selection 541. The sports charting system can scroll through these statistics by when the user inputs the statistics scroll buttons 543.

The sports charting system captures forced and unforced errors. This is an important charting statistic as it shows whether a player's errors are being forced or are just attributable to poor or deficient techniques. Other statistics generated and displayed are break point conversions percentage 546, at net percentage 548, net success percentage 550, elapsed time 552, average point duration 554 and average hits per point 556. The elapsed time 552 is the total elapsed time for the match at the time of the elapsed time inquiry by the user. The average point duration 554 is the elapsed time for each point.

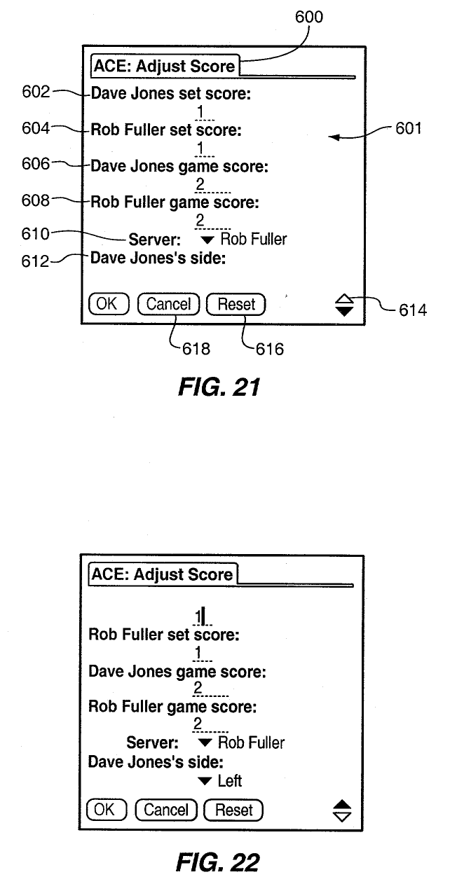

FIG. 20 is an illustration of the scoreboard display 570. Among the data displayed on the scoreboard display 570 are the first set score 580, second set score 582, player 578, set score 576, game score 574 and point score 572. FIGS. 21 and 22 are illustrations of the adjust score display 601. Among the scores that can be adjusted by the user include a first player set adjust score 602, a second player set adjust score 604, a first player game adjust score 606 and a second player game adjust score 608. The user can also adjust the server and player orientation with the server adjust 610 and a player's side adjust 612. Up/down arrows 614 allow the user to scroll through the displays that are longer than one page.

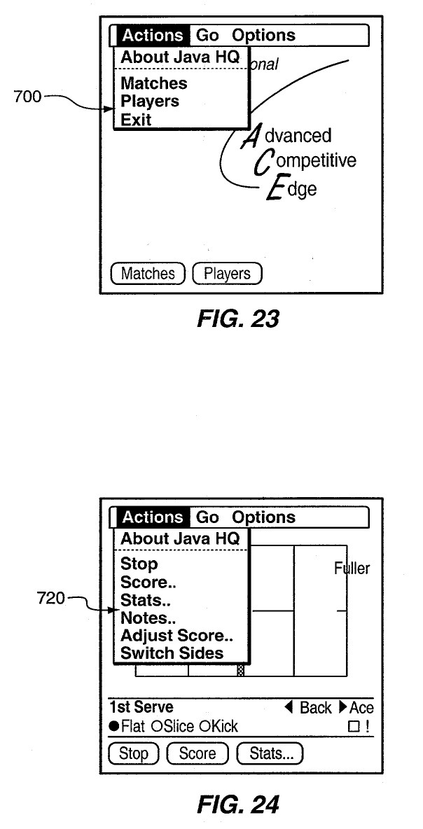

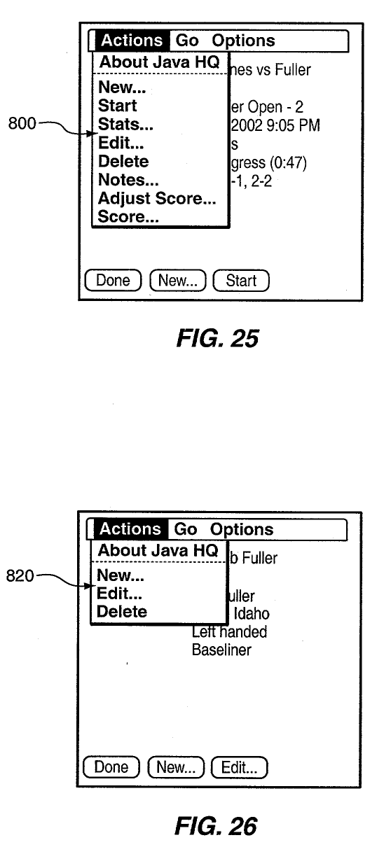

FIG. 23 is an illustration of the main screen display menus 700. FIG. 24 is an illustration of the serving and playing display menus 720. FIG. 25 is an illustration of the matches dialog display menu 800. FIG. 26 is an illustration of the players dialog display menu 820.

The sports charting system uses match controllers, set controllers, game controllers and point controllers that collectively embody the rules of tennis to generate, responsive to a user's inputted match type, the required number of points, tiebreakers, games, sets and matches without the user needing to enter this data. A match controller is responsible for playing a tennis match, by creating new sets when they are necessary, saving sets to internal persistent storage, knowing how to keep set scores and when a match has been completed. A set controller is responsible for playing a set, by creating new games when necessary, saving games to internal persistent storage, and knowing how to keep game scores and when a set has been completed. A game controller is responsible for playing a game, by creating new points when necessary, saving points to internal persistent storage, and knowing how to keep point scores and when a game has been completed. A point controller is responsible for playing a point, by knowing about the serve, return and playing portion of a point.

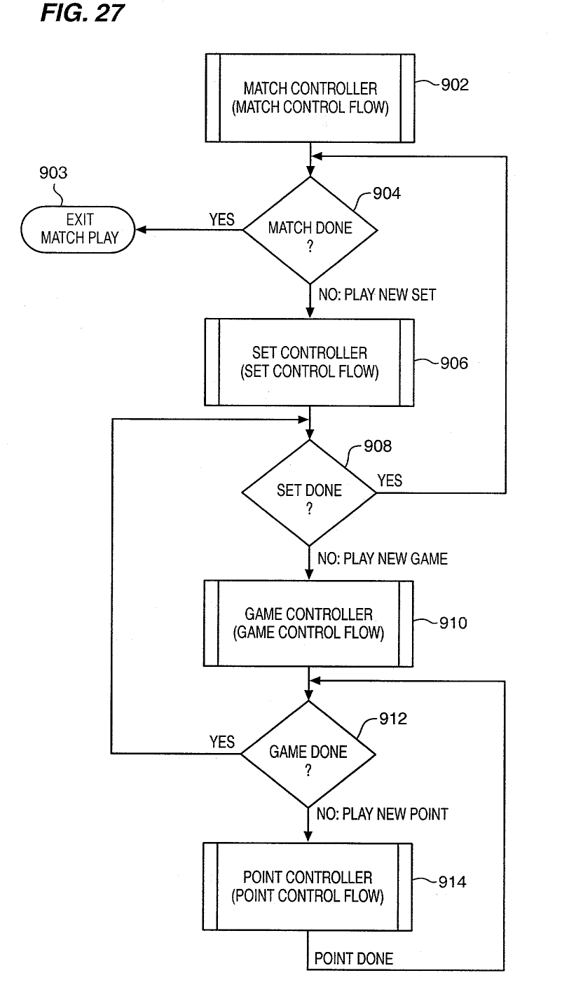

FIG. 27 is a flow chart for the sports charting system for generating the required matches, sets, games, points and serves for a tennis match. The sports charting system through a match controller 902 proceeds to the match done inquiry 904. If the match is done, then the sports charting system exits the match play 903. If the match is not done, then the sports charting system, through a set controller 906, proceeds to the set done inquiry 908. If the set is done, then the sports charting system returns to the match done inquiry 904. If the set is not done, then the sports charting system, through a game controller 910, proceeds to the game done 912. If the game is done, then the sports charting system returns to the set done inquiry 908. If the game is not done, then the sports charting system to a point controller 914.

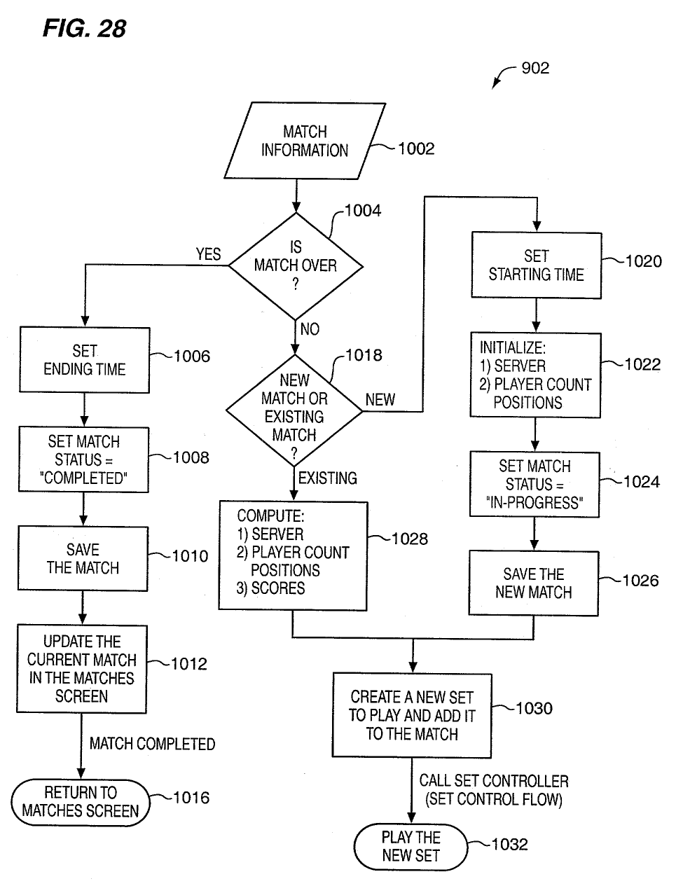

FIG. 28 is a flow chart for the sports charting system for the match controller 902. Match information 1002 is retrieved from storage by the sports charting system. The match controller 902 starts its process by proceeding to the match over inquiry 1004. If the answer to the match over inquiry 1004 is yes, the match controller 902 proceeds to set match ending time 1006. It then proceeds to the set match status completed 1008. It then proceeds to save the match 1010, and then proceeds to update current match 1012 in the matches display 271. Then the match controller 902 proceeds to return and displays 1016 the matches screen 271. If the answer to the match over inquiry 1004 is no, then the match controller 902 proceeds to the new/existing match inquiry 1018. If the answer to the new/existing match inquiry 1018 is new, then the match controller 902 proceeds to the set match starting time 1020, then the match controller 902 proceeds to the initialize match 1022. The initialize match 1022 initializes the server and the player court positions. The match controller 902 then proceeds to the set match status in progress 1024, then it proceeds to the save new match 1026. If the answer to the new/existing match inquiry 1018 is “existing”, then the match controller 902 proceeds to compute match 1028. The compute match 1028 computes the server, player court positions and the scores. Both the compute match 1028 and the save new match 1026 proceed to the create new set process 1030. The create new set process 1030 creates a new set to play and adds it to the match. Then the create new set process 1030 proceeds to the play new set process 1032.

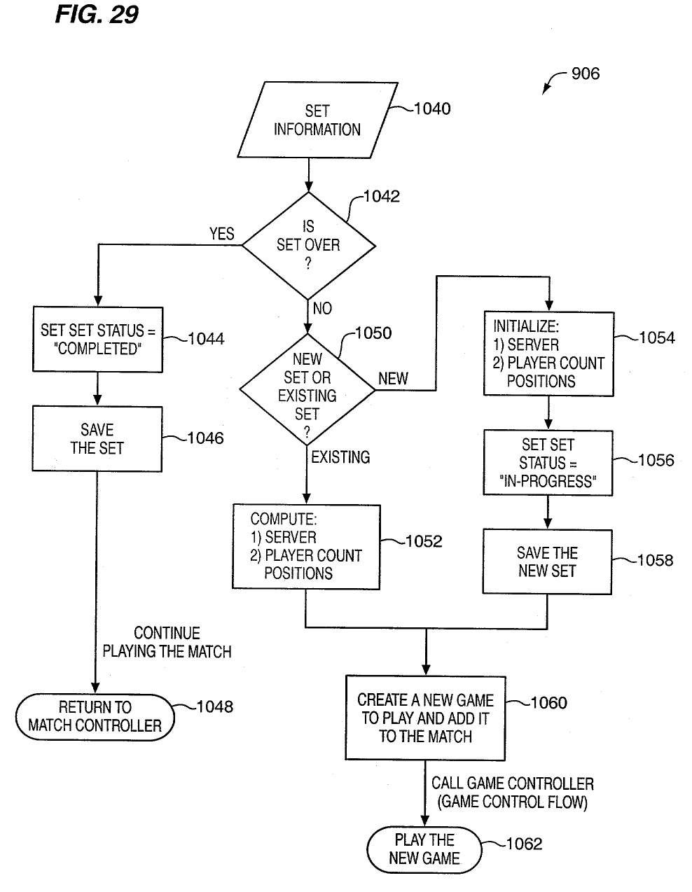

FIG. 29 is a flow chart for the sports charting system for the set controller 906. Set information 1040 is retrieved from storage by the sports charting system. The set controller 906 starts its process by proceeding to the set over inquiry 1042. If the answer to the set over inquiry 1042 is yes, the set controller 906 proceeds to set status completed 1044. It then proceeds to save the set 1046, and then proceeds to return 1048 to the match controller 902. If the answer to the set over inquiry 1042 is no, then the set controller 906 proceeds to the new/existing set inquiry 1050. If the answer to the new/existing set inquiry 1050 is new, then the set controller 906 proceeds to the initialize set 1054. The initialize set 1054 initializes the server and the player court positions. The set controller 906 then proceeds to the set status in progress 1056, then it proceeds to the save new set 1058. If the answer to the new/existing set inquiry 1050 is “existing”, then the set controller 906 proceeds to compute set 1052. The compute set 1052 computes the server and player court positions. Both the compute set 1052 and the save new set 1058 proceed to the create new game process 1060. The create new game process 1060 creates a new set to play and adds it to the match. Then the create new game process 1060 proceeds to the play new game process 1062.

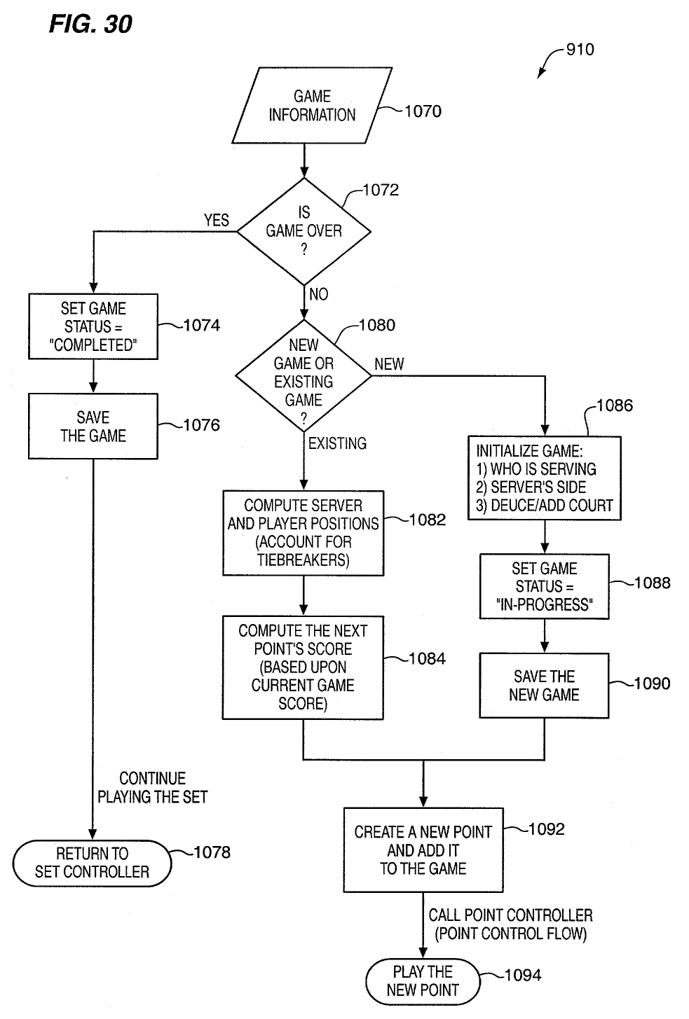

FIG. 30 is a flow chart for the sports charting system for the game controller 910. Game information 1070 is retrieved from storage by the sports charting system. The game controller 910 starts its process by proceeding to the game over inquiry 1072. If the answer to the game over inquiry 1072 is yes, the game controller 910 proceeds to game status completed 1074. It then proceeds to save the game 1076, and then proceeds to return 1078 to the set controller 906. If the answer to the game over inquiry 1072 is no, then the game controller 910 proceeds to the new/existing game inquiry 1080. If the answer to the new/existing game inquiry 1080 is new, then the game controller 910 proceeds to the initialize game 1086. The initialize game 1086 initializes who is serving, the server's side and the deuce/add court arrangement. The game controller 910 then proceeds to the game status in progress 1088, then it proceeds to the save new game 1090. If the answer to the new/existing game inquiry 1080 is “existing”, then the game controller 910 proceeds to compute game 1082. The compute game 1082 computes the server and player court positions and accounts for tiebreakers. The game controller 910 then proceeds to the compute next point score 1084. The compute next point score 1084 computes the next point's score based upon the current game score. Both the compute next point score 1084 and save new game 1090 proceed to the create new point process 1092. Create new point process 1092 creates a new point and adds it to the game. Then the create new point process 1092 proceeds to the play new point 1094.

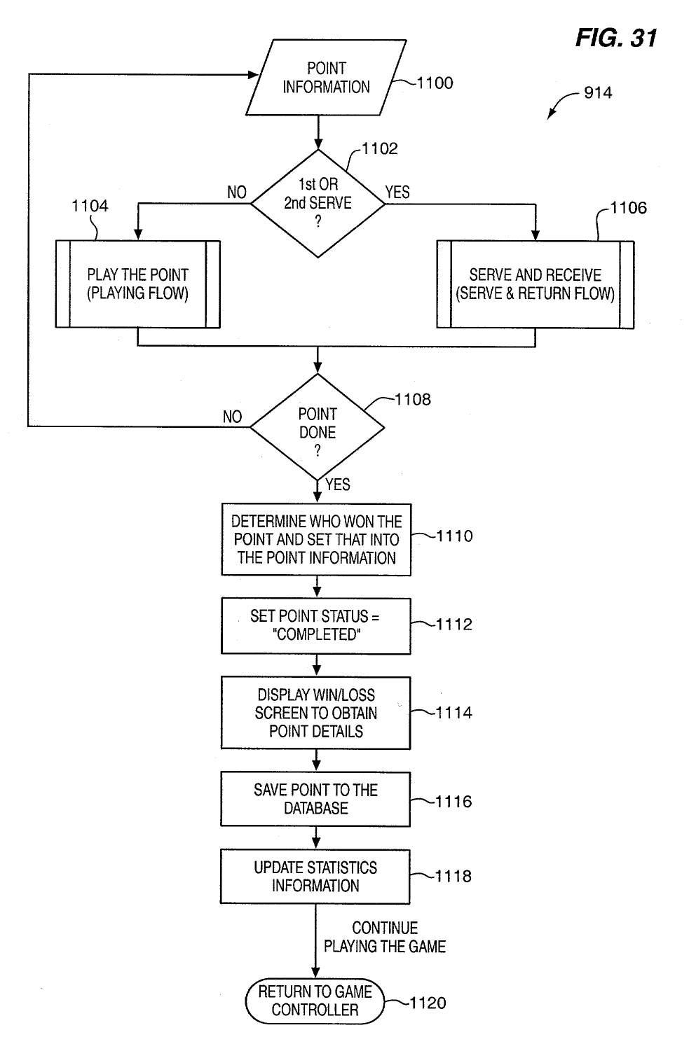

FIG. 31 is a flow chart for the sports charting system for the point controller 914. Point information 1100 is retrieved from storage by the sports charting system. The point controller 914 starts its process by proceeding to the first/second serve inquiry 1102. If the answer to the first/second serve inquiry 1002 is no, then the point controller 914 proceeds to the play the point flow 1104. If the answer to the first/second serve inquiry 1002 is yes, then the point controller 914 proceeds to the serve and receive flow 1106. Both the play the point flow 1104 and the serve and receive flow 1106 proceed to the point done inquiry 1108. If the answer to the point done inquiry 1108 is no, then the point controller 914 proceeds to the point information 1100. If the answer to the point done inquiry 1108 is yes, then the point controller 914 proceeds to the determine winner 1110. The determine winner 1110 determines who won the point and sets that information into the point information 1100. Then the point controller proceeds to the set point status completed 1112. Then it proceeds to the win/loss-playing display 477 to obtain point details. Then it proceeds to the save point to the storage 1116. Then the point controller 914 proceeds to the update statistics information 1118. Then the point controller 914 proceeds to the game controller 910.

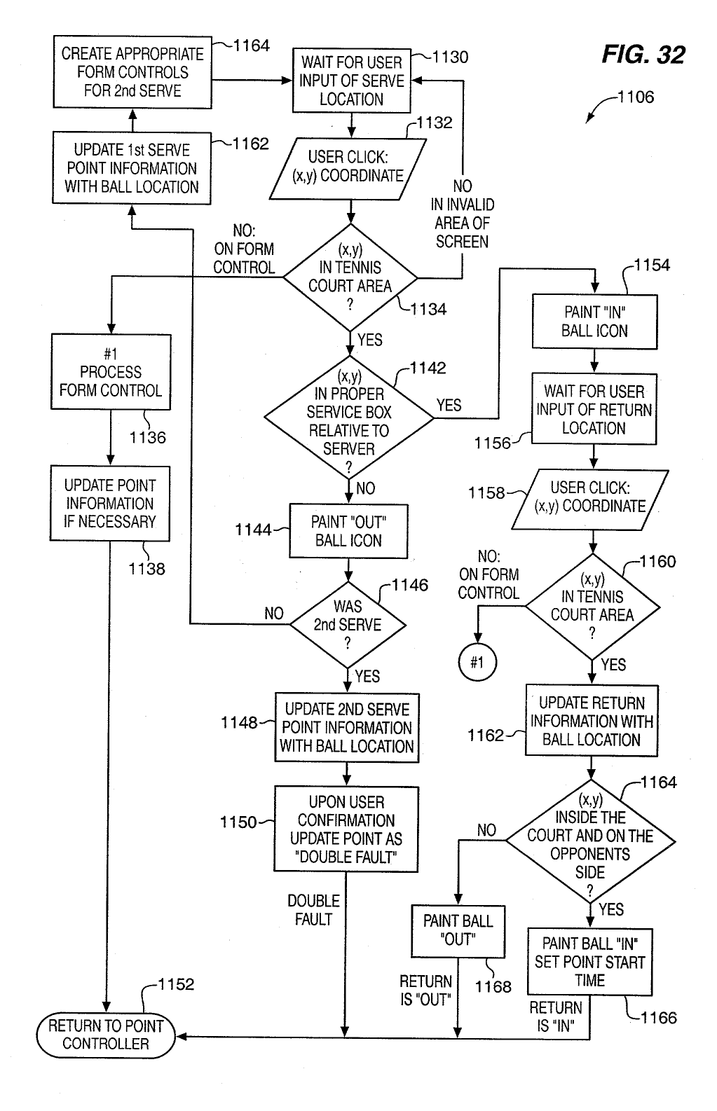

FIG. 32 is a flow chart for the sports charting system for the serve and receive flow 1106. The serve and receive flow 1106 begins at the user input serve location 1130. Then the serve and receive flow 1106 proceeds to the user click serve location 1132. Then the serve and receive flow 1106 proceeds to the court area serve inquiry 1134. If the answer to the court area serve inquiry 1134 is no, then the serve and receive flow 1106 proceeds to process form control 1136. Then it proceeds to the update point information 1138. Then the serve and receive flow 1106 returns 1152 to the point controller 914. If the answer to the court area serve inquiry 1134 is yes, then the serve and receive flow 1106 proceeds to the service box inquiry 1142. If the answer to the service box inquiry 1142 is no, then the serve and receive flow 1106 proceeds to the paint “out” ball icon 1144. Then the serve and receive flow 1106 proceeds to the second serve inquiry 1146. If the answer to the second serve inquiry 1146 is yes, then the serve and receive flow 1106 proceeds to the update second serve 1148. The update second serve 1142 updates the second serve point information with the ball location. Then the serve and receive flow 1106 proceeds to the double fault update 1150. The double fault update 1150 upon user confirmation, updates the point as a double fault. Then the serve and receive flow 1106 returns 1152 to the point controller 914. If the answer to the second serve inquiry 1146 is no, then the serve and receive flow 1106 proceeds to the update first serve 1162. The update first serve 1162 updates the first serve point information with the ball location. The serve and receive flow 1106 then proceeds to the create second serve form controls 1164. The create second serve form controls 1164 creates the appropriate form controls for the second serve. Then the serve and receive flow 1106 proceeds to the user input serve location 1130. If the answer to the service box inquiry 1142 is yes, then the serve and receive flow 1106 proceeds to the paint in ball icon 1154. Then the serve and receive flow 1106 proceeds to the user input return location 1156. Then the serve and receive flow 1106 proceeds to the user click return location 1158. Then the serve and receive flow 1106 proceeds to the court area return inquiry 1160. If the answer to the court area return inquiry 1160 is no, then the serve and receive flow 1106 proceeds to process form control 1136. If the answer to the court area return inquiry 1160 is yes, then the serve and receive flow 1106 proceeds to the update return location 1162. The update return location 1162 updates the return location with the ball location. Then the serve and receive flow 1106 proceeds to the inside court/opponents side inquiry 1164. The inside court/opponents side inquiry 1164 inquires as to whether the location of the ball return is inside the court and on the opponent's side. If the answer to the inside court/opponents side inquiry 1164 is yes, then the serve and receive flow 1106 proceeds to the paint ball in 1166. The paint ball in 1166 paints the ball in and sets the point start time. Then the serve and receive flow 1106 returns 1152 to the point controller 914. If the answer to the inside court/opponents side inquiry 1164 is no, then the serve and receive flow 1106 proceeds to the paint ball out 1168. Then the serve and receive flow 1106 returns 1152 to the point controller 194.

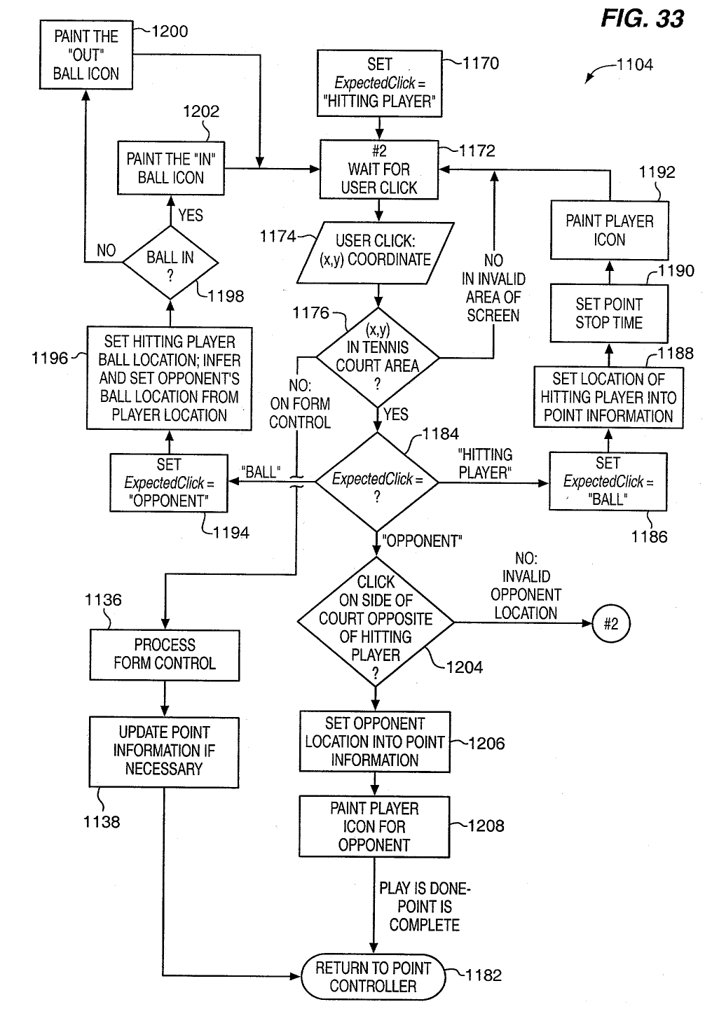

FIG. 33 is a flow chart for the sports charting system for the play and point flow 1104. The expected click is set to hitting player 1170. Then play and point flow 1104 proceeds to the user input player location 1172. Then the play and point flow 1104 proceeds to the user click player location 1174. Then the play and point flow 1104 proceeds to the court area shot inquiry 1176. If the answer to the court area shot inquiry 1176 is no, then the play and point flow 1104 proceeds to the process form control 1136. The play and point flow 1104 then proceeds to the update point information 1138. Then the play and point flow 1104 returns 1182 to the point controller 914. If the answer to the court area shot inquiry 1176 is yes, then the play and point flow 1104 proceeds to the expected click inquiry 1184. This expected click inquiry 1184 has three options: ball, hitting player and opponent. If the answer to the expected click inquiry 1184 is ball, then the play and point flow 1104 proceeds to the expected click opponent 1194. Then the play and point flow 1104 proceeds to the set hitting player location 1196. The set hitting player location 1196 sets the hitting player ball location and infers and sets the opponents ball location from the player location. Then the play and point flow 1104 proceeds to the ball in inquiry 1198. If the answer to the ball in inquiry 1198 is no, then the play and point flow 1104 proceeds to the paint the ball out icon 1200. If the answer to the ball in inquiry 1198 is yes, then the play and point flow 1104 proceeds to the paint the ball in icon 1202. Then the play and point flow 1104 proceeds to the user input player location 1172.

If the answer to the expected click inquiry 1184 is opponent, then the play and point flow 1104 proceeds to the click on opposite side of hitting player inquiry 1204. If the answer to the click on opposite side of hitting player inquiry 1204 is yes, then the play and point flow 1104 proceeds to the set opponent location into point information 1206. Then the play and point flow 1104 proceeds to the paint player icon for opponent 1208. Then the play and point flow 1104 returns 1182 to the point controller 914. If the answer to the expected click inquiry 1184 is hitting player, then the play and point flow 1104 proceeds to the expected click ball 1186. Then the play and point flow 1104 proceeds to the set location of hitting player 1188. The set location of hitting player 1188 sets the location of the hitting player into the point information 1100. The play and point flow 1104 then proceeds to the set point stop time 1190. Then the play and point flow 1104 proceeds to the paint player icon 1192. Then the play and point flow 1104 proceeds to the user input player location 1172.

### EXAMPLE 1

Player Properties Input

A user powers on the sports charting system and selects the players selection 206. The user then selects the new selection 218, then the user enters a player's profile information, typically including: the first name data field 231, last name data field 232, age data field 233, city data field 234 and state data field 235. The user then enters a player's profile information in the pull-down menus such as left/right handedness menu 236, forehand menu 237, backhand menu 238, typical forehand menu 241, typical backhand menu 242 and weapon menu 244. The user then inputs a first and a second serve for a player in the first serve menu 246 and second serve menu 248, both of which are pull-down menus that list flat, kick or slice as selections the user can select. The user then inputs the style of play of the player like whether the player is an all-court player, a baseliner, a counter-puncher or a serve and vollyer. The user then inputs whether the player is good under pressure or not in the good under pressure menu 260 and whether the player typically comes from behind in the comes from behind menu 262. The user then types text into the player and team profile data in a notes section 264 regarding any observations the user has made of the player, like is the player limping, is the player's wrist weak and limp when the player hits the ball. The user then inputs the player properties OK selection 239 and the sports charting system returns to the home display 202.

### EXAMPLE 2

Match Properties Input

A user selects matches selection 204 from the home display 202 of the sports charting system. Then the user selects the new selection 276 on the match properties display 289. The user then inputs a title of a match in the tournament field 290. The user then inputs the round data in a round field 292. The user then inputs the surface type in a pull-down menu that lists grass, hardcourt and clay. The user then inputs the player and the player's opponent into the player menu 298 and the opponent menu 300 which are pull-down menus that lists stored players and teams in the sports charting system that the user can select. The user then inputs the type of match that the player and opponent will be playing in a type menu 302 which is a pull-down menu that lists 3-Set, 5-Set and Pro-Set as selections the user can select. The user then inputs a whether the match will have no-add scoring and what the tiebreak requirement will be in the no-add scoring menu 304 and the tiebreaker menu 310. The user then inputs the points in the tiebreaker in the points in tiebreaker data entry field 312 where the user inputs the number of points of the tiebreaker. The user then inputs which player or team is serving first in the serving first menu 314 and on which side the server is serving on in the starts on side menu 316. The user then types text into the type text freeform notes 320 regarding any observations the user has made of the match and/or player. The user then inputs the match properties OK selection 305 and the sports charting system returns to the matches display 271.

### EXAMPLE 3

Charting a Service

The user inputs player properties and match properties according to Examples 1 and 2 as mentioned above. The user then starts charting a match from the matches display 271. The user inputs the start selection 274 and the first serve display 430 is displayed. If the serve is an ace the user inputs the location of the ace in the non-serving player's court's serving box and selects the ace selection 420. The user also notes in the service default value 414 whether the ace was a default value or a different serve. The sports charting system automatically adjusts the score of the match and the next point is ready to be charted. For example in the case of a double fault, the user inputs the first serve and the second serve location as being out. The sports charting system automatically adjusts the score of the match and the next point is ready to be charted. For example in the case where the first serve is out and the second serve is in, the user inputs the ball out location of the first serve and in location of the second serve.

### EXAMPLE 4

Charting a Point

The user charts the serve as mentioned above in Example 3. Once a serve is in, the user inputs the location of the service return. If the service return is out of the court the user inputs its location and the sports charting system determines the service return is out and after the sports charting system receives stroke data regarding the errant shot, the score is automatically adjusted and the players court location is changed according to the rules of tennis prior to the beginning of the next point. If the service return is in, the sports charting system then briefly displays the location of both the in serve and the service return balls before it displays the playing screen display 449. The user can then input the number of shots made by both players by inputting these strokes in the stroke counter 452. The stroke counter 452 is also advanced by the use of other user input, such as the space bar or the up/down arrows of a keyboard or by a user click. If one of the players hits an errant shot out of the court, then the user inputs the errant shot player location, the errant ball location and the winning point player location. The sports charting system determines and displays the locations of the errant shot player location, the errant ball location and the winning point player location, receives winning and losing stroke data and automatically adjusts the score of the match and players court locations according to the rules of tennis. If one of the players hits a winning shot, then the user inputs the winning point player location, the winning point player ball location and the losing point player location and the sports charting system determines and displays these locations, the sports charting system then receives winning and losing shot data and automatically adjusts the score of the match and the players court location is changed according to the rules of tennis prior to the beginning of the next point.

### EXAMPLE 5

Point and Scoring Determinations

FIG. 28 illustrates in flow diagram form the sports charting system processes for determining the score of a point. In tennis, a serve signifies the beginning of a point. The sports charting system stores rules of a particular sport and uses these rules in determining the score, statistics and outcome of a particular point. The sports charting system begins the determining process by inquiring whether this is the beginning of a point. If it is the beginning of a point, then the sports charting system displays the serve/receive display 920 and proceeds to the service in inquiry 1002. If the serve is in, the sports charting system awaits the user input of the service return in inquiry 1004. If the service return is in, then the sports charting system awaits the user input of the service return ball location. Then the sports charting system briefly displays the service ball location and the service return ball location, and if the return is a “winner” or is out displays the playing screen win/loss display 916. If the service return is out, the sports charting system determines, based on the stored rules of the game of tennis, that the point is over and advances the score of the server and the players court location is changed according to the rules of tennis prior to the beginning of the next point. In this example, the user inputs a first serve that is out and the sports charting system displays the out first serve by displaying an “X” on the serve/receive display 920. Then the user inputs a second serve that is in and inputs a service return that is in. The sports charting system determines that the point is being played by comparing the ball positions of the second serve and the service return to the stored rules of the game of tennis. The sports charting system then accepts user input regarding the number of strokes hit by the players during the point and displays the number to the screen. The user then inputs a first player location and the ball location hit by the first player. If the ball location is out of the court, then the sports charting system determines that the first player is a point losing player and that the second player is a point winning player, receives winning and losing shot data and advances the score of the point winning player and adjusts the player positions according to the rules of tennis. The sports charting system also keeps statistics regarding the location of the point winning player and point losing player during the point. If the ball location is in the court, then the sports charting system awaits the location of the second player and then makes the determination that the first player is the point winning player and the second player is a point losing player. The sports charting system also keeps statistics regarding the location of the point winning player, the point losing player and the ball.

### EXAMPLE 6

Heuristically Predicting Default Values

The user charts the serve as mentioned above in Example 3. Once a serve is in, the user inputs the location of the service return. If the service return is out of the court, the user inputs its location and the sports charting system determines the service return is out, receives data about the errant shot and the score and player positions are automatically adjusted. If the service return is in, the sports charting system then briefly displays the location of both the in serve and the service return balls before it displays the playing screen display 449. The user can then input the number of shots made by both players by inputting these strokes in the stroke counter 452. The stroke counter 452 is also advanced by the use of other user input, such as the space bar or the up/down arrows of a keyboard or by a user click. For this example the players are both right handed and both have a forehand as a weapon. The user inputs the point winning player location 460 in the deuce court, the winning player's ball location 462 and the point losing player location 463 in the deuce court on the other side. The sports charting system heuristically predicts the default value for the winning point player and the losing point player shot side hit on selection 486 is “forehand” for both players.

Summary

The sports charting system is used for analysis of a sporting performance of a player or players. The sports charting system displays one or many sport environments. The sports charting system accepts user inputs regarding a player's position and a sport apparatus position relative to the sport environment. The sports charting system processes the real-time statistics of the sporting performance from the player's position and the sport apparatus position as entered by the user. The sports charting system then displays the player's position and the sport apparatus position relative to the sport environment and displays selected statistics data and scoring data generated from the player's position and the sport apparatus position relative to the sport environment. The sports charting system also stores the statistics data generated by the processes and from the user.

The sports charting system uses player profile information, sport performance rules, common practices and well-established facts of a particular sport to heuristically predict default values for user input.

Although there has been described what is at present considered to be the preferred embodiments of the present invention, it will be understood that the invention can be embodied in other specific forms without departing from the spirit or essential characteristics thereof. The present embodiments are, therefore, to be considered in all aspects as illustrative and not restrictive. The scope of the invention is indicated by the appended claims rather than the foregoing description.

What is claimed is:

1. A sports charting system used for analysis of at least one sporting performance of at least one player, said system comprising:
means for displaying at least one sport environment;
means for inputting a player positional data and a sport apparatus positional data relative to said sport environment; and
means for processing the real-time statistics of said at least one sporting performance from said player positional data and said sport apparatus positional data;
wherein said display means depicts said player positional data and said sport apparatus positional data relative to said sport environment and displays at least one of: selected statistics data and scoring data generated from said player positional data and said sport apparatus positional data relative to said sport environment by said means for processing.

2. The sports charting system of claim 1 further comprising:
means for storing said data generated by said means for processing and from said means for inputting.

3. The sports charting system of claim 1 wherein said means for processing is responsive to a user inputting a sport match definition, for generating the required number of sport match definition subdivisions from said sport match definition.

4. The sports charting system of claim 1 wherein said means for processing is responsive to a user inputting a sport game orientation for generating a sport environment incorporating said sport game orientation on said means for display.

5. The sports charting system of claim 2 wherein said means for processing comprises:
means, responsive to said player positional data and said sport apparatus positional data, for placement of said at least one player on said display relative to said sport environment before the beginning of each of said sport match definition subdivisions.

6. The sports charting system of claim 1 further comprising:
means for storing at least one player profile comprising a set of data having default values; and
means for inputting at least one player profile data, to replace at least one default value.

7. The sports charting system of claim 1 wherein said means for inputting a player positional data and a sport apparatus positional data relative to said sport environment comprises:
means, responsive to a user input, for displaying at least one player positional data relative to said sport environment corresponding to said user input.

8. The sports charting system of claim 1 wherein said means for inputting a player positional data and a sport apparatus positional data relative to said sport environment comprises:
means, responsive to a user input, for displaying at least one sport apparatus positional data relative to said sport environment corresponding to said user input.

9. The sports charting system of claim 1 wherein said means for inputting comprises:
means, responsive to a user input, for counting the number of plays in a sporting performance.

10. The sports charting system of claim 1 wherein said means for inputting comprises:
means, responsive to a user input, for inputting environmental data of said at least one sport environment.

11. The sports charting system of claim 2 wherein said means for inputting comprises:
means, responsive to a user input, for inputting play data for said match definition subdivisions.

12. The sports charting system of claim 1 wherein said means for processing comprises:
means, responsive to a user input, for generating a user selected statistics data.

13. The sports charting system of claim 1 wherein said means for processing comprises:
means for comparing said at least one player profile data with that of another at least one player profile data;
wherein said comparing means determines differences and equalities of the compared said player profile data.

14. The sports charting system of claim 1 wherein said means for storing further comprises storing tactical data.

15. The sports charting system of claim 14 wherein said means for processing comprises:
means, responsive to said player positional data, for comparing said player positional data with said tactical data;
wherein said comparing means determines the differences and equalities between said player positional data and said tactical data.

16. The sports charting system of claim 15 further comprising:
means for storing at least one sport performance rule; and
means for determining said at least one default value from at least one of: said at least one player profile, said at least one sport performance rule, said player positional data, and said tactical data.

17. The sports charting system of claim 1 wherein said means for processing comprises:
means, responsive to a user input, for editing said scoring data.

18. The sports charting system of claim 5 wherein said means for processing comprises:
means, responsive to a user input, for editing said placement of said at least one player on said display relative to said sport environment before the beginning of each of said sport match definition subdivisions.

19. The sports charting system of claim 1 wherein said means for processing comprises:
means, responsive to said real-time statistics, for generating tactical structure format data.

20. A method used for analysis of at least one sporting performance of at least one player, comprising the steps of:
displaying at least one sport environment;
inputting a player positional data and a sport apparatus positional data relative to said sport environment;
processing the real-time statistics of said at least one sporting performance from said player positional data and said sport apparatus positional data;
wherein said step of displaying depicts said player positional data and said sport apparatus positional data relative to said sport environment and displays at least one of: selected statistics data and scoring data generated from said player positional data and said sport apparatus positional data relative to said sport environment by said processing in real-time; and
storing said data generated by said processing and from said inputting.

21. The method of claim 20 further comprising the step of:
processing is responsive to a user inputting a sport match definition, for generating the required number of sport match definition subdivisions from said sport match definition.

22. The method of claim 20 further comprising the step of:
processing is responsive to a user inputting a sport game orientation for generating a sport environment incorporating said sport game orientation on said means for display.

23. The method of claim 21 further comprising the step of:
placing, in response to said player positional data and said sport apparatus positional data, said at least one player on said display relative to said sport environment before the beginning of each of said sport match definition subdivisions.

24. The method of claim 20 further comprising the steps of:
storing at least one player profile comprising a set of data having default values; and
inputting at least one player profile data, to replace at least one default value.

25. The method of claim 20 further comprising the step of:
displaying, responsive to a user input, at least one player positional data relative to said sport environment corresponding to said user input.

26. The method of claim 20 further comprising the step of:
displaying, responsive to a user input, at least one sport apparatus positional data relative to said sport environment corresponding to said user input.

27. The method of claim 20 further comprising the step of:
counting, responsive to a user input, the number of plays in a sporting performance.

28. The method of claim 20 further comprising the step of:
inputting, responsive to a user input, environmental data of said at least one sport environment.

29. The method of claim 21 further comprising the step of:
inputting, responsive to a user input, play data for said match definition subdivisions.

30. The method of claim 20 further comprising the step of:
generating, responsive to a user input, a user selected statistics data.

31. The method of claim 20 further comprising the step of:
comparing said at least one player profile data with that of another at least one player profile data;
wherein said comparing determines differences and equalities of the compared said player profile data.

32. The method of claim 20 further comprising the step of storing further comprises storing tactical data.

33. The method of claim 32 further comprising the step of comparing said player positional data with said tactical data;
wherein said comparing determines the differences and equalities between said player positional data and said tactical data.

34. The method of claim 33 further comprising the steps of:
storing at least one sport performance rule; and
determining said at least one default value from at least one of: said at least one player profile, said at least one sport performance rule, said player positional data, and said tactical data.

35. The method of claim 20 further comprising the step of:
editing, responsive to a user input, said scoring data.

36. The method of claim 23 further comprising the step of:
editing, responsive to a user input, said placement of said at least one player on said display relative to said sport environment before the beginning of each of said sport match definition subdivisions.

37. The method of claim 20 further comprising the step of:
generating, responsive to said real-time statistics, tactical structure format data.

38. A product that provides a sports charting system for analysis of a sporting performance of at least one person, said product comprising:
instructions for directing a processing unit to:
display at least one sport environment;
input a player positional data and a sport apparatus positional data relative to said sport environment;
process the real-time statistics of said at least one sporting performance from said player positional data and said sport apparatus positional data; wherein said display depicts said player positional data and said sport apparatus positional data relative to said sport environment and displays at least one of: selected statistics data and scoring data generated from said player positional data and said sport apparatus positional data relative to said sport environment by said processing in real-time; and
store said data generated by said processing and from said input.

39. The product of claim 38 wherein said instructions further comprise instructions for directing said processing unit to process responsive to a user inputting a sport match definition, to generate the required number of sport match definition subdivisions from said sport match definition.

40. The product of claim 38 wherein said instructions further comprise instructions for directing said processing unit to process responsive to a user inputting a sport game orientation for a sport environment incorporating said sport game orientation on said display.

41. The product of claim 38 wherein said instructions further comprise instructions for directing said processing unit to place said at least one player on said display relative to said sport environment before the beginning of each of said sport match definition subdivisions.

42. The product of claim 38 wherein said instructions further comprise instructions for directing said processing unit to:
store at least one player profile, comprising a set of data having default values; and
input at least one player profile data, to replace at least one default value.

43. The product of claim 38 wherein said instruction further comprise instructions for directing said processing unit to display, responsive to a user input, at least one player positional data relative to said sport environment corresponding to said user input.

44. The product of claim 38 wherein said instruction further comprise instructions for directing said processing unit to display, responsive to a user input, at least one sport apparatus positional data relative to said sport environment corresponding to said user input.

45. The product of claim 38 wherein said instructions further comprise instructions for directing said processing unit to count, responsive to a user input, the number of plays in a sporting performance.

46. The product of claim 38 wherein said instructions further comprise instructions for directing said processing unit to input, responsive to a user input, environmental data of said at least on sport environment.

47. The product of claim 38 wherein said instructions further comprise instructions for directing said processing unit to input, responsive to a user input, play data for said match definition subdivisions.

48. The product of claim 38 wherein said instructions further comprise instructions for directing said processing unit to generate, responsive to a user input, a user selected statistics data.

49. The product of claim 38 wherein said instructions further comprise instructions for directing said processing unit to compare said at least one player profile data with that of another at least one player profile data;
wherein, said compare determines differences and equalities of the compared said player profile data.

50. The product of claim 38 wherein said instructions further comprise instructions for directing said processing unit to store tactical data.

51. The product of claim 50 wherein said instructions further comprise instructions for directing said processing unit to compare differences and equalities between said player positional data and said tactical data.

52. The product of claim 51 wherein said instruction further comprise instructions for directing said processing unit to:
store at least one sport performance rule; and
determine said at least one default value from at least one of: said at least one player profile, said at least one sport performance rule, said player positional data, and said tactical data.

53. The product of claim 38 wherein said instructions further comprise instructions for directing said processing unit to edit, responsive to a user input, said scoring data.

54. The product of claim 41 wherein said instruction further comprise instruction for directing said processing unit to edit, responsive to a user input, said placement of said at least one player on said display relative to said sport environment before the beginning of each of said sport match definition subdivisions.

55. The product of claim 38 wherein said instructions further comprise instructions for directing said processing unit to generate, responsive to said real-time statistics, tactical structure format data.

56. A method used for analysis of at least one sporting performance of at least one player, comprising the steps of:
storing at least one sport performance rule;
displaying at least one sport environment;
inputting a player positional data and a sport apparatus positional data relative to said sport environment;
retrieving said sport performance rules;
comparing said player positional data and said sport apparatus positional data relative to said sport environment with said at least one sport performance rule to determine compliance with said at least one sport performance rule;
generating, responsive to said comparing, at least one of selected statistics data and scoring data; and
displaying said at least one of selected statistics data and scoring data.

57. The method of claim 56 wherein said step of comparing comprises:
determining if said player positional data and said sport apparatus positional data relative to said sport environment equals said sport performance rule.

58. The method of claim 56 wherein said step of comparing comprises:
displaying, responsive to said user input, at least one sport apparatus positional data relative to said sport environment corresponding to said user input.

59. The method of claim 56 wherein said step of comparing comprises:
displaying, responsive to said user input, at least one player positional data relative to said sport environment corresponding to said user input.

60. A method used for charting a tennis match, comprising the steps of:
storing at least one sport performance rule;
inputting at least one player properties data and at least one match properties data;
displaying at least one sport environment;
inputting a player positional data and a ball positional data relative to said sport environment;
generating at least one of selected statistics data and scoring data; and
displaying said at least one of selected statistics data and scoring data.

61. The method of claim 60 wherein said step of displaying comprises:
generating, responsive to said at least one match properties data, the required number of tennis match definition subdivisions.

62. The method of claim 60 wherein said step of generating comprises:
comparing said player positional data and said ball positional data relative to said sport environment with said at least one sport performance rule to determine compliance with said at least one sport performance rule.

63. The method of claim 60 wherein said step of inputting comprises:
inputting a service ball positional data relative to said sport environment; and
inputting a service return ball positional data relative to said sport environment.

64. The method of claim 63 wherein said step of generating comprises:
determining, responsive to said inputting said service ball positional data and said inputting service return ball location, at least one of selected statistics data and scoring data.

65. The method of claim 60 wherein said step of inputting comprises:
inputting a first player position relative to said sport environment;
inputting a first player ball location relative to said sport environment;
inputting a second player position relative to said sport environment.

66. The method of claim 65 wherein said step of generating comprises:
setting a second player ball location equal to said first player location relative to said sport environment.

67. The method of claim 65 wherein said step of generating comprises:
determining, responsive to said inputting, at least one of selected statistics data and scoring data.

68. The method of claim 60 further including the step of:
storing said at least one of selected statistics data and scoring data.

69. A method for determining a default value comprising:
storing at least one sport performance rule;
displaying at least one sport environment;
storing at least one tactical data;
inputting a player positional data and a sport apparatus positional data relative to said sport environment;
determining said default value from at least one of: said at least one player profile, said at least one sport performance rule, said player positional data, and said tactical data.
